(19) United States
(12) Patent Application Publication
(10) Pub. No.: US 2008/0118304 A1
(43) Pub. Date: May 22, 2008

(54) Rebar Junction Clip And Method For Securing Rebar Thereby

(76) Inventors: John M. Carraher, Salem, OR (US); Terry D. Newton, Turner, OR (US)

Correspondence Address: ATER WYNNE LLP, 222 SW COLUMBIA, SUITE 1800, PORTLAND, OR, 97201-6618, US

(21) Appl. No.: 11/662,620

(22) PCT Filed: Aug. 25, 2005
(86) PCT No.: PCT/US05/30270

§ 371 Date: Mar. 12, 2007

Related U.S. Application Data
(60) Provisional application No. 60/608,434, filed on Sep. 10, 2004.
(60) Provisional application No. 60/610,601, filed on Sep. 17, 2004.

(51) Int. Cl. F16G 11/06

(52) U.S. Cl. 403/396; 403/400

(57) ABSTRACT

The invented fastener device includes a unitary clip having a base and two spaced clamps, each clamp having opposing fingers, one stiff and spring deflectable under force. Flanged surfaces at the distal ends of the stiff and spring members form a wedge for deflecting the spring member to force an elongate, cylindrical object, e.g. a length of rebar, broadside into one of two stacked conduits. The region between the two clamps is generally U-shaped to accommodate a length of rebar into a transverse conduit with the clip. The base includes male and female appendages for coupling adjacent ones of the clips together in a strain, and it also includes two or more guide pins oriented transverse to the coupling appendages for guiding such a train down a race within a track of a dispensing applicator. A preferably integrally molded “chair” or platform for elevating the clip a desired height above a surface is described.

### RELATED APPLICATIONS

The present application claims priority to U.S. Provisional Patent Application Ser. No. 60/608,434, entitled UNIVERSAL REBAR CLIP and filed Sep. 10, 2004, and U.S. Provisional Patent Application Ser. No. 60/610,601, entitled UTILITY CLIP REBAR GUN and filed Sep. 17, 2004, the disclosures of which are incorporated herein in their entirety by this reference.

### BACKGROUND OF THE INVENTION

This invention relates generally to the field of reinforcement bar (rebar) fasteners as they are used to join two or more lengths of rebar to reinforce a concrete slab, pillar, footing or wall. More particularly, it concerns rebar fasteners used to securely fasten together two lengths of rebar in various relative orientations at a two-rebar junction.

Rebar fasteners are old. They have been used for years to fasten two or more lengths of rebar within a volume of concrete to stabilize a concrete structure such as a slab, pillar, footing or wall. Lengths of rebar typically are joined in parallel as an extension or in perpendicular as a cross or at a corner. Conventional rebar fasteners are formed of tie wires or metal clips. Fastening rebar lengths together using conventional rebar fasteners thus requires lengths of wire or formed wire fasteners, fastening tools such as a pair of pliers or pincers and lots of potentially repetitive-motion labor and resultant injury. Moreover, wire or metal fasteners create conditions that produce chemical reactions, e.g. so-called ‘creeping’ electrolysis, with even coated rebar that can cause discoloration (a dark ‘blooming’ on the cured concrete surface) and corrosion of the cured concrete and that can erode the rebar junction's structural integrity.

Metal wire tends to lose strength when twisted and thus to produce loose junctions having the tendency to further loosen over time. Wire and metal clips can scar rebar, promoting undesirable electrolysis, rusting, and/or corrosion of the rebar at the scar site. Furthermore, wire or metal fasteners are susceptible to oil, solvents and acids that may permeate a concrete structure work site. Finally, wire or metal fasteners are separated from one another and are configured to be employed one at a time. Thus conventional rebar fasteners do not lend themselves to serial dispensing thereof as from a magazine clip of, for example, a semi-automatic rebar clip fastener ‘gun.’

### SUMMARY OF THE INVENTION

The invented fastener device includes a unitary clip having a base and two spaced apart clamps, each clamp having opposing fingers, one stiff and one spring deflectable under force. Flanged surfaces at the distal ends of the stiff and spring members form a wedge for deflecting the spring member to force an elongate, cylindrical object, e.g. a length of rebar, broadside into one of two stacked conduits. The region between the two clamps is generally U-shaped to accommodate a length of rebar into a transverse conduit within the clip. The base includes male and female appendages for coupling adjacent ones of the clips together in a train, and it also includes two or more guide pins oriented transverse to the coupling appendages for guiding such a train down a race within a track of a dispensing applicator. A preferably integrally molded “chair” or platform for elevating the clip a desired height above a surface is described.

### BRIEF DESCRIPTION OF THE DRAWINGS

FIG. 1 is an isometric view of the fastener made in accordance with one embodiment of the invention.

FIG. 2 is a left-side elevation illustrating in phantom outline an open position and in solid outline a closed position of a resilient clasp that forms a part of the fastener of FIG. 1.

FIG. 3 is a front elevation of the fastener of FIG. 1.

FIG. 4 is a top view of the fastener of FIG. 1.

FIGS. 5A and 5B are isometric views of the fastener of FIG. 1 used respectively to fasten two parallel rebar lengths and two perpendicular rebar lengths.

FIG. 6 is an isometric view of the rebar fastener of FIG. 1 integrally molded with a platform that elevates the fastener at different heights above a concrete-pouring surface such as the ground.

### DETAILED DESCRIPTION OF THE PREFERRED EMBODIMENTS

The invention in accordance with a preferred embodiment involves an integrally molded, nylon, generally C-shaped clip that is dimensioned and structured to fixedly position and secure two elongate, generally cylindrical objects, e.g. two lengths of rebar, therein in parallel or perpendicular orientation relative to one another. A so-called ‘chair’ or elevator also is provided to position the clip at a desired elevation above the ground so that a junction can be formed thereat.

Those of skill in the art will appreciate that the invention is particularly suited for securely fastening two rebar lengths together in a predetermined orientation relative to one another, but that other applications are contemplated as being within the spirit and scope of the invention. For example, copper tubes or pipe or PVC pipe and other plumbing hardware can be joined using the invented fastener. Electrical applications include the joinder of appliance cables or cords such as computer or Ethernet cords using the fastener. Heating Ventilation and Air Conditioning (HVAC) applications abound. Indeed, junctions between two or more flexible or rigid tubes, rods, bars or other elongate, generally cylindrical objects are possible with the invented fastener. Thus, rebar junctions are only one illustrative and particularly useful application of the invented fastener.

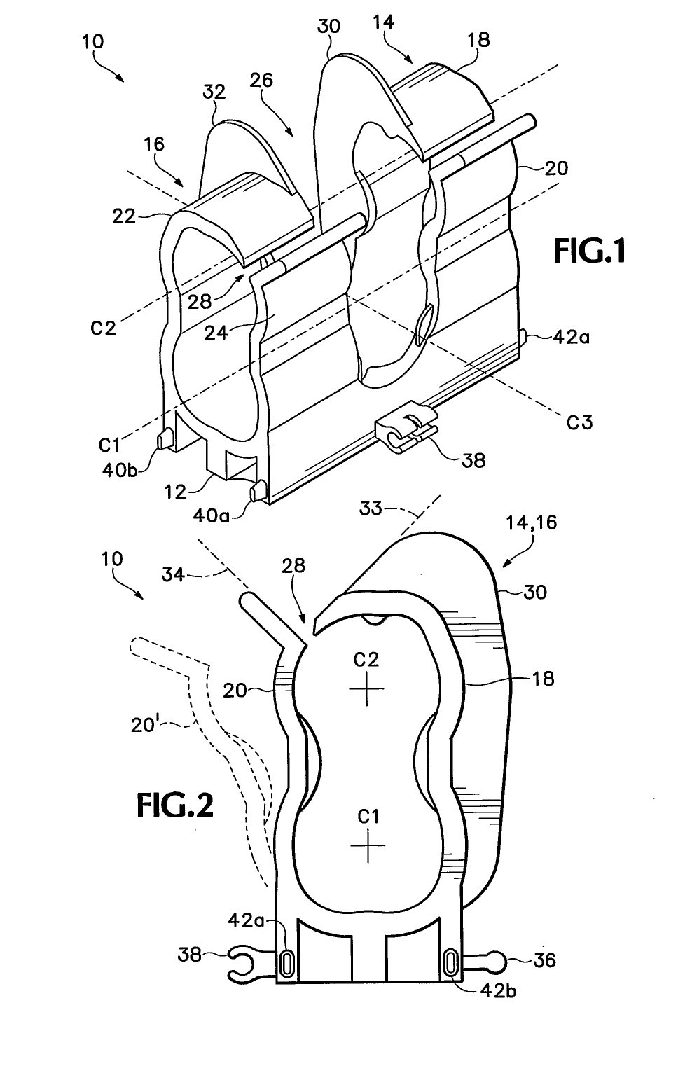

FIG. 1 is an isometric view of the invented rebar fastener clip 10 in accordance with one embodiment of the invention. Clip 10 preferably is made of a polymer, e.g. nylon, and is integrally molded as a unitary piece. Nylon 6 is the preferred material, which has been found to provide the desired strength of material, durability and reliability. Clip 10 in accordance with one embodiment of the invention includes a base 12 from which extend two axially spaced-apart, mirror-image clamps 14, 16. Clamp 14 includes a so-called stiff finger 18 and a so-called spring finger 20, the two fingers extending upwardly from the base generally parallel with one another. Clamp 16 includes a stiff finger 22 and a spring finger 24, the two fingers also extending upwardly from the base generally parallel with one another.

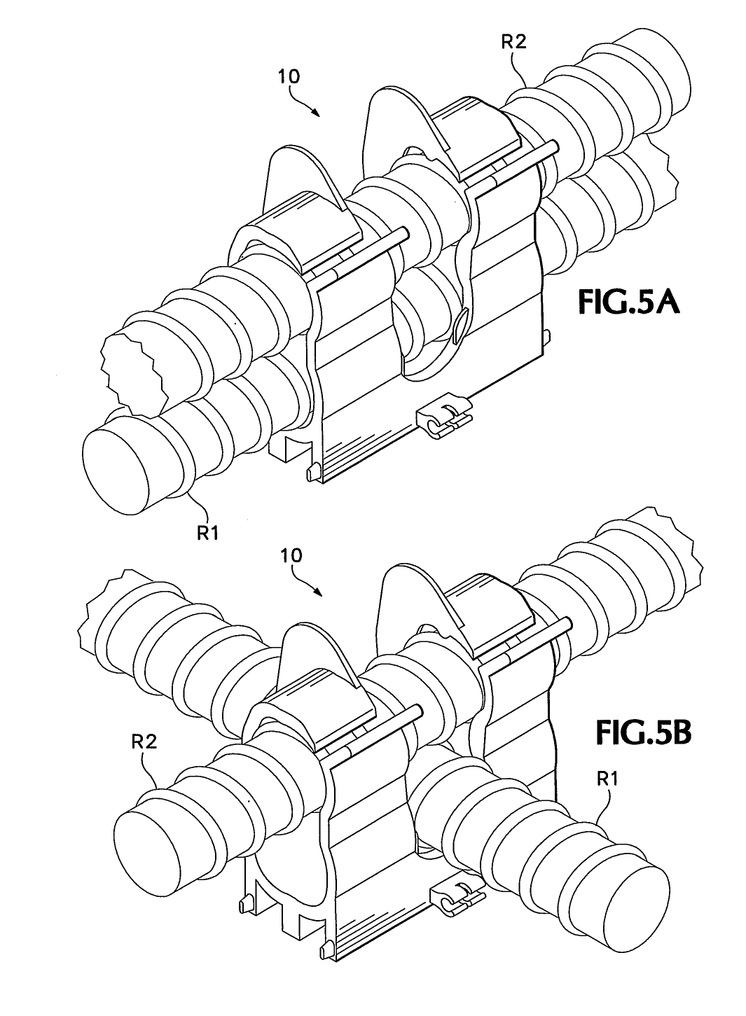

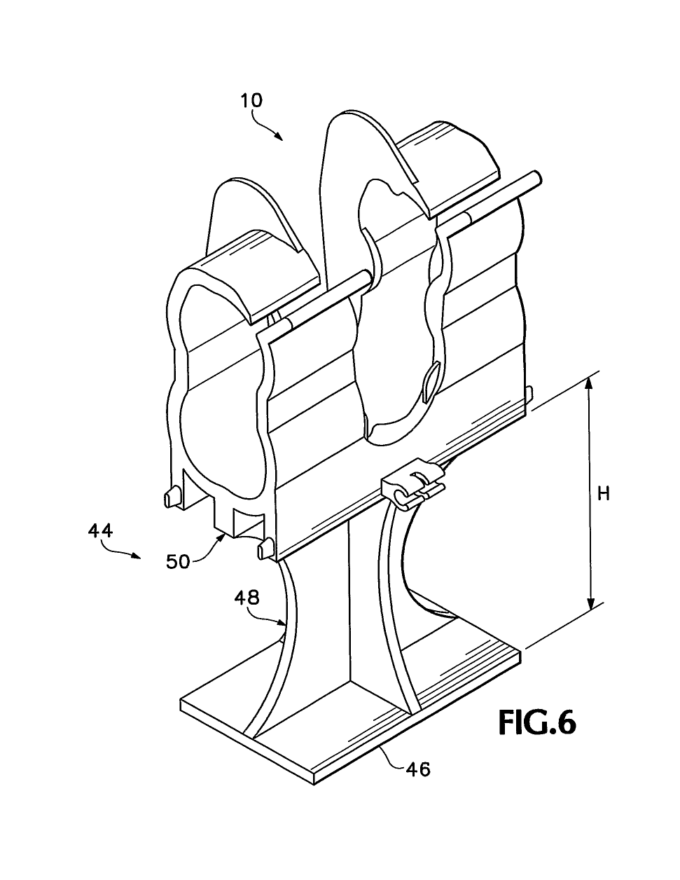

Referring collectively now to FIGS. 1 and 2, stiff fingers 18, 22 and spring fingers 20, 24 include complexly curved interior surfaces that may be understood collectively to define two generally cylindrical conduits C1, C2 that extend along the axial alignment of clamps 14, 16 in parallel with one another. In FIG. 1, the long axes of these conduits are indicated by dash-dot lines. In FIG. 2, the long axes of these conduits are indicated by +signs. It will be understood that conduits C1, C2 are sized in accordance with the invention to receive therethrough in substantially parallel alignment two lengths of reinforcement bar (rebar) of a given gauge. This is more clearly illustrated in FIG. 5A, which represent a parallel arrangement of rebar lengths within device 10.

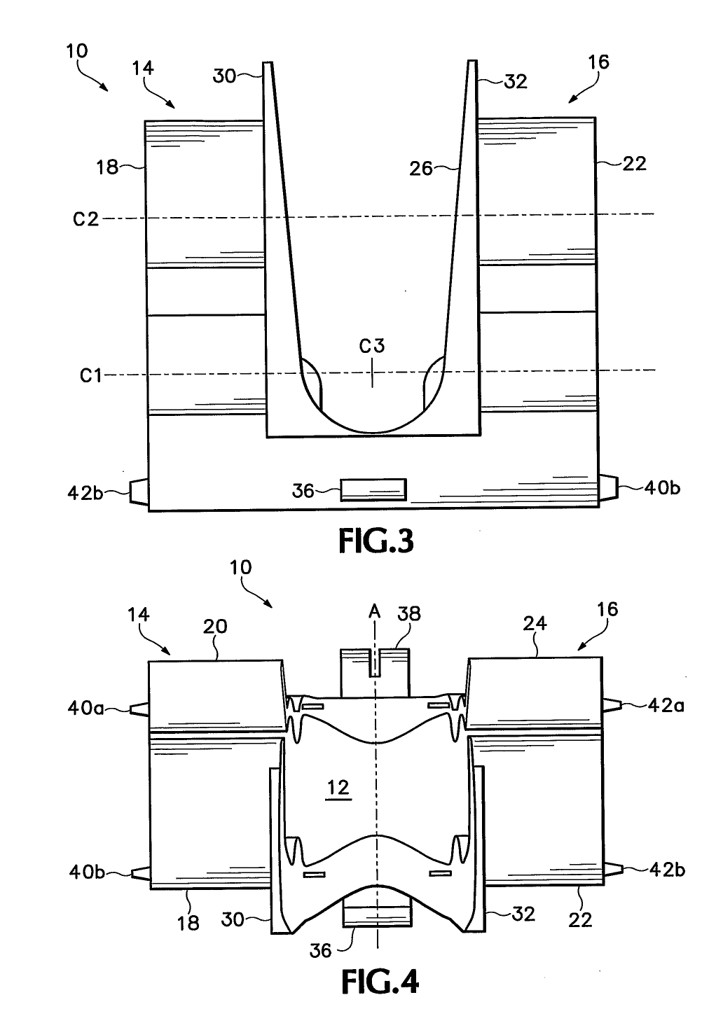

Referring collectively now to FIGS. 1 and 3, a generally U-shaped opening 26 between axially aligned but spaced-apart clamps 14, 16 defines in a bottom region thereof a third generally cylindrical conduit C3 that extends along an axis that is perpendicular to the axes of conduits C1, C2. Conduit C3 is indicated in FIG. 1 by a dash-dot line and in FIG. 3 by a +sign, and conduits C1, C2 are indicated in FIG. 3 by dash-dot lines. Those of skill in the art will appreciate from FIG. 3 that conduits C2 and C3 preferably are at approximately the same elevation above base 12. It will be understood that conduit C3 is sized in accordance with the invention to receive therethrough in substantially parallel alignment a length of rebar of a give gauge. This is more clearly illustrated in FIG. 5B, which represents an alternative, perpendicular arrangement of two rebars lengths within device 10.

Referring collectively to FIGS. 1, 2 and 3, clamps 14 and 16 and U-shaped opening 26, and their cooperation in joining rebar at different angles, will be described in detail. Conduits C1 and C2 may be understood to have a closable opening 28 thereto referred to herein as a mouth. Opening can be seen from FIGS. 1 and 2 normally to be substantially closed, but a dashed line in FIG. 2 describes an opened, or deflected, position of spring finger 20 (and aligned spring finger 24, not visible in FIG. 2) of clamp 14 (and aligned clamp 16, not visible) that permits the broadside introduction of one or more rebar lengths (not shown) into conduit C1 or C2 or both. Those of skill in the art will appreciate that, after the temporary deflection of spring finger 20 into the phantom open position indicated at 20′—by impingement on the distal ends of stiff finer 18 and spring finger 20 of a force vector directed toward the base (and in the direction of the arrow in FIG. 2)—spring finger 20 by spring action substantially closes opening 28 to capture the one or more lengths of rebar in proper axial alignment within conduits C1, C2 or both.

By use of conduit C3 and C2, alternatively, tow rebar lengths can be fastened in substantially perpendicular alignment with one another in the following manner. A first length of conduit is introduced through U-shaped opening 26 against the base thereof, with the rebar length's long axis in axial alignment with conduit C3. Next, a second length of rebar is introduced into opening 28 against the first rebar length, with the second rebar's long axis in axial alignment with conduit C2. It will be appreciated that opening 26 to conduit C3 effectively is closed by the introduction into conduit C2 of the second length of rebar, whereas opening 28 to conduit C2 is closed by spring action of spring arm 20.

Referring collectively to FIGS. 1 and 2, it can be seen that stiff arms 18, 22 preferably include ribs 30, 32 that extend outwardly and upwardly away from base 12 in parallel planes. Those of skill in the art will appreciate that ribs 30, 32 reinforce stiff arms 18, 22 to render them not readily deflectable, e.g. relatively fixed and immovable, relative to base 12. In accordance with one embodiment of the invention, ribs 30, 32 have a substantial upward and outward extent from base 12 (best shown in FIG. 2), as well as a substantial thickness (best shown in FIG. 3). Those of skill in the art also will appreciate that ribs 30, 32 extend substantially along the entire length of stiff arms 18, 22, respectively, along their outer surface. It will also be appreciated that ribs 30, 32 taper along their upwardly extending length, thus contributing somewhat more stiffness near base 12 than near flange 33.

In accordance with one embodiment of the invention hard-tooled and molded of nylon 6, rebar fastener device 10 provides up to approximately 165 pounds of load-bearing capacity, in terms of being able to withstand without failure repeated forces of that magnitude impacting between first flanges 33 of stiff arms 18, 22 and second flanges 34 of spring arms 20, 24. Alternative materials and structural details are contemplated as producing less high-performance rebar fastening devices that nevertheless are within the spirit and scope of the invention.

Moreover, ribs 30, 32 and their stiff fingers 18, 22 can be seen near a distal end thereof to terminate in a first plane that is tilted approximately 45° (up and right in FIG. 2) from the horizontal. This plane will be referred to herein as a first flange 33 (see dash-dot line in FIG. 2). Spring fingers 20, 24 can be seen near a distal end thereof to terminate in a second plane that it tilted approximately 45° (up and left in FIG. 2) from the horizontal. This plane will be referred to herein as a second flange 34 (see dash-dot line in FIG. 2). Those of skill in the art will appreciate that acutely angled and confronting first and second flanges 33, 34 provide a wedging action temporarily to leverage spring finger 20 from its closed position to its open position under impingement by a force directed in a downward direction in FIG. 2, e.g. by the force of manually introducing a rebar length broadside into opening 28. After a length of rebar is through opening 28 and in conduit C1 or C2, it will be understood that the distal ends of spring fingers 20, 24 snap-return to their closed positions immediately adjacent the distal ends of stiff fingers 18, 22.

Those of skill will appreciate that the invented rebar clip may be dimensioned to secure various sizes of rebar, including industry-standard sizes, 3, 4, 5, 6, 7, 8, 9 and 10 gauge, where rebar gauges represent the diameter of the rebar in multiples of ⅛ inch, e.g. size 4 rebar is nominally ½ inch in diameter.

Thus, generally cylindrical conduits C1, C2 and C3 can vary in diameter depending upon the gauge of rebar to be introduced therein and joined thereby. This is a straightforward matter that involves dimensioning the base and opposing fingers in accordance with a nominal diameter of the rebar corresponding with present and future gauges, as needed. It will be understood that molding tools can be constructed to provide the alternative conduit diameters and that inventories can be maintained to accommodate the various device sizes by their suitability for various gauges of rebar. In accordance with another aspect of the invention, a single fastening device can accommodate various rebar sizes, e.g. one or more of the diameters of C1, C2 and C3 can differ from those of the one or more others. Finally, in accordance with an aspect of the invention, the invented device can be color coded, e.g. by dyeing the nylon casting compound, to aid in quick, visual identification of the conduit size or size combinations corresponding with various rebar gauges.

Rebar clips made of nylon in accordance with the invention do not rust and are resistant to creeping electrolysis or chemical reaction with solvents and acids that are commonly found at construction sites. And while conventional rebar is made of preferably coated iron, the invented rebar clip is not so limited. Within the spirit and scope of the invention, the invented rebar clip can be used with any metal, metal alloy, plastic, glass, polymer or other rebar material, whether coated or not.

FIG. 4 is a top view of rebar fastener 10. Base 12 of fastener 10 is generally rectangular, as illustrated, and has a ribbed bottom (refer briefly to FIG. 1) for increased planarity and strength. Base 12 includes a male appendage 36 and a corresponding female appendage 38 extending outwardly therefrom in opposite directions along a common axis A. Those of skill in the art will appreciate that male and female appendages 36, 38 are securely engage-able respectively with a corresponding female and a corresponding male appendage (referred to herein as a male/female couple) of an adjacent one or more of fastener devices 10 positioned along common axis A. Thus, in accordance with one embodiment of the invention, plural instances of device 10 can be physically coupled together in a train using the male/female couples. This enables successive dispensing and applying of fastener devices 10 via semi-automatic means.

Male and female appendages 36, 38 in accordance with the invention are generally cylindrical and elongate, or barrel-shaped, as can be seen best perhaps from FIGS. 1-4, with a barrel-shaped male appendage made to slightly interference-fit (snap-fit) within a barrel-shaped opening in the female appendage. This provides axial alignment of the couples transverse to the direction of travel of plural coupled fasteners 10 (which direction of travel preferably is along axis A), thus ensuring stable tracking therebetween. Alternative shapes and alignments are contemplated as being within the spirit and scope of the invention. For example, a spherical male appendage and spherical female opening also might robustly couple adjacent fastener devices, albeit with less stability against lateral forces, e.g. forces transverse to axis A, impinging on the train of devices.

FIG. 4 also shows oppositely outwardly facing pairs of guide pins 40a, 40b, 42a, 42b aligned with an axis perpendicular to axis A. Such guide pin pairs are provided in accordance with one embodiment of the invention to guide trains of coupled fastener devices 10 along a race provided on a track or in a magazine of a ‘gun’ that advances, dispenses and applies a succession of devices 10 to rebar junctions. Such a ‘gun’ is described and illustrated in co-pending, above referenced U.S. Provisional Patent Application Ser. No. 60/610,601. Those of skill in the art will appreciate that, alternatively yet within the spirit and scope of the invention, guide pins 40a, 40b, 42a, 42b might be aligned along axis A and male and female appendages 36, 38 might be aligned perpendicular to axis A, in effect interchanging the locations of the coupling and guidance structures relative to base 12 of device 20.

The rate of application of conventional metal wire rebar fasteners is only approximately four/minute, yielding only approximately 1920 applications per average worker per day. In stark contrast, approximately twenty of the invented clips can be applied per minute using a hammer, a five-fold rate increase. Moreover, using a dispensing gun having a spring-loaded magazine compatible with successive feeding and dispensing of plural clips in a latched interconnect strip, 1920 applications per hour are possible, representing an astounding order of magnitude increase in rate and commensurate decrease in labor costs.

FIGS. 5A and 5B are isometric views of rebar fastener 10 used, respectively, to fasten two parallel rebar lengths and two perpendicular rebar lengths. Lengths of rebar R1, R2 are shown in FIG. 5A to be securely fastened in parallel alignment with one another within device 10. Such “extension” rebar fastening is useful to extend the reach of long rebar runs. Lengths of rebars R1, R2 alternatively are shown in FIG. 5B to be securely fastened in perpendicular alignment with one another within device 10. Such alternative “cross” rebar fastening is useful to create rebar grids or so-called ‘mats.’ Those of skill in the art will appreciate that, in FIGS. 5A and 5B, R1 is introduced in both cases into fastener device 10 precedent in time to the introduction thereinto of R2, as described above.

FIG. 6 is an isometric view of rebar fastener 10 integrally molded with a so-called “chair” or platform to elevate the clip above the ground, in accordance with another embodiment of the invention. Those of skill in the art will appreciate that rebar junctions typically are most useful in a generally centrally interior region of a slab of concrete. Thus, for concrete footings or slabs, it is often needed to elevate the rebar junction to a height consistent with one or more intermediate heights within, e.g. an approximately intermediate height of, the concrete slab or layer being poured, so that maximum reinforcement thereof is possible. A simple but novel platform 44 is provided in accordance with another embodiment of the invention to support and stabilize a rebar junction for fastening with the invented clip.

Platform 44 includes a preferably rib-reinforced base region 46 and a variable-height (H), rib-reinforced upright region 48 an upper, generally planar extent 50 of which generally is shaped and dimensioned to be substantially congruent (coextensive) with base 12 of fastener device 10 supported thereby. Those of skill in the art will appreciate that platform 44 in accordance with one embodiment of the invention is made, e.g. preferably molded, also of nylon 6 for its structural durability and integrity. Platform 44 and fastener device 10 if molded separately can simply mate in vertical alignment while rebar is applied to the upward-facing opening 26 and/or upward-facing opening 28. Alternatively, fastener device 10 can be suitably adhered at its base 12 to the upper extent 50 of platform 44. Height H typically ranges from approximately 3-5 inches for most concrete slab applications.

In accordance with one preferred embodiment of the invention, fastener device 10 and platform 44 take the form of a unitary structure, i.e. they are integrally molded, from a nylon casting compound. Alternative embodiments of platform 44 with device 10 in useful combination, however, are contemplated as being within the spirit and scope of the invention.

It will be understood that the present invention is not limited to the method or details of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides an inexpensive piece-part and labor cost alternative for fastening lengths of rebar. The invention provides a novel rebar junction fastener that is easily and inexpensively manufactured and easily and quickly installed without repetitive motion injury. The rebar fastener is uniquely constructed for joining two elongate, generally cylindrical objects, e.g. two lengths of rebar, in parallel alignment in a so-called extension or in perpendicular alignment in a so-called cross. The rebar fastener can be variously sized to accommodate rebar of various gauges, and the various sizes can be color coded for quick and easy size identification. The rebar fastener preferably is made of nylon that does not react with the rebar, thus to avoid rebar corrosion and so-called concrete blooming. Finally, the rebar fastener provides hooks for dispensing and applying them one at a time from a magazine holding a train of interlocked fasteners in a semi-automated so-called ‘gun.’ The invention provides an optional, and optionally integrally molded, platform or so-called ‘chair’ for elevating a rebar junction at a chosen height above a support surface such as the ground.

It is further intended that any other embodiments of the present invention that result from any changes in field or application or method of use or operation, method of manufacture, shape, size, or material which are not specified within the detailed written description or illustrations contained herein yet are considered apparent or obvious to one skilled in the art are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

We claim:

1. A reinforcement bar (rebar) fastener device comprising:
a unitary clip including two or more conduits therein configured to accommodate up to two lengths of rebar extending therethrough, at least two of the two or more conduits being aligned substantially in parallel with or perpendicular to one another,
each of the two or more conduits having a closable opening thereto for introducing a length of rebar thereinto, at least one of the closable openings being closed by spring action of an elongate closure member that extends from a base of the unitary clip.

2. The fastener device of claim 2, wherein the unitary clip includes three or more conduits at least two of which are aligned substantially in parallel with one another and at least two of which are aligned substantially in perpendicular with one another, and wherein the closable opening to another of the two or more conduits is closable by introducing a second rebar into the at least one closable opening after a second rebar has been introduced into and positioned within the other of the two or more conduits.

3. The fastener device of claim 2 which further comprises:
an elongate ribbed member extending from the base opposite the closure member,
wherein the closure member, the base and the ribbed member form a generally U-shaped expanse as the fastener device is viewed along the at least two conduits which are aligned substantially in parallel with one another.

4. The fastener device of claim 3, wherein the closure member includes a a deflectable distal end opposite the base, the distal end nominally being at rest in a closure position but being deflectable outwardly away from the ribbed member to open, the distal end including a first region of curvature inwardly toward the ribbed member to produce substantial closure and a second region distal of the first region of abrupt curvature outwardly away from the ribbed member to produce a flange for leveraging open the distal end of the closure member open when the flange and the distal end of the ribbed member are impinged upon by a force exerted inwardly toward the base.

5. The fastener device of claim 4, wherein the base includes a male appendage and a female appendage extending outwardly therefrom in opposite directions along a common axis, the male appendage and the female appendage being securely engageable respectively with a corresponding female and a corresponding male appendage of an adjacent one or more of the fastener devices positioned along the common axis.

6. The fastener of claim 5, wherein the male and female appendages are generally cylindrical in shape and elongate with a central long axis of the cylinder being transverse to the common axis.

7. The fastener device of claim 5, wherein the base further includes two or more guide pins extending outwardly therefrom along an axis transverse from the common axis, the guide pins being configured to track within a race of an external plural-device magazine of a dispensing applicator.

8. The fastener device of claim 7, wherein the two or more guide pins number four and wherein pairs of pins located on either side of the base are spaced apart from one another.

9. The fastener device of claim 8, wherein the unitary clip is integrally molded.

10. The fastener device of claim 9, wherein the unitary clip is made from a material including nylon.

11. A reinforcement bar (rebar) fastener device comprising:
a unitary clip including two axially spaced apart clamps extending from a base;
wherein each clamp includes a pair of opposing fingers including a stiff finger and a spring finger that is resiliently deformable to open a mouth between the spring finger and the stiff finger, the stiff finger and the spring finger cooperating to define therebetween first and second generally cylindrical conduits in parallel axial alignment, the first and second conduits being configured to accommodate therethrough one or more lengths of rebar;
the two axially spaced apart clamps defining therebetween a generally U-shaped opening an apex of which defines a third generally cylindrical conduit substantially perpendicular with the first and second conduits, the third conduit being configured to accommodate therethrough a length of rebar.

12. The fastener device of claim 11, wherein a distal end of the stiff finger of each clamp includes a first flange and wherein a distal end of the spring finger of each clamp includes a second flange, the first and second flanges being configured as an openable mouth, the first and second flanges cooperating under a force vector aimed toward the base as a wedge resiliently to deflect the spring finger outwardly away from the stiff finger thereby temporarily to open the mouth of each clamp.

13. The fastener device of claim 12, wherein the stiff finger of each clamp includes a reinforcement rib extending substantially around its peripheral outer surface.

14. The fastener device of claim 13, wherein the base includes a male appendage and a female appendage extending outwardly therefrom in opposite directions along a common axis, the male appendage and the female appendage being interlockable respectively with a corresponding female and a corresponding male appendage of an adjacent fastener device positioned along the common axis.

15. The fastener device of claim 14, wherein the base further includes two or more guide pins extending outwardly therefrom in opposite directions substantially perpendicular from the common axis, the guide pins being configured to slidingly engage a race in a dispensing magazine capable of containing plural interlocked ones of the fastener device.

16. The fastener device of claim 15, wherein the unitary clip is integrally molded.

17. The fastener device of claim 16, wherein the unitary clip is made from a material including nylon.

18. A reinforcement bar (rebar) fastener system comprising:
a rebar clip integrally molded of a durable resilient material, the clip including three generally cylindrical conduits two of which are substantially parallel with one another and one of which is substantially perpendicular to the substantially parallel two conduits, the substantially parallel two conduits being configured for fastening two lengths of rebar therein in substantially parallel alignment and the substantially perpendicular one conduit being configured for fastening a length of rebar therein in substantially perpendicular alignment with a length of rebar fastened in one of the substantially parallel two conduits; and
a platform for supporting the rebar clip in a fixed position and orientation thereon, the platform having a predefined height for elevating the rebar clip above a surface that supports the platform.

19. The system of claim 18, wherein the rebar clip has a base and a spring-loaded mouth opposite the base, and wherein the rebar clip is supported by the platform with the base oriented downwardly and with the mouth oriented upwardly.

20. The system of claim 19, wherein the rebar clip and the platform are integrally molded together.
